(19) United States
(12) Patent Application Publication
(10) Pub. No.: US 2023/0413200 A1
(43) Pub. Date: Dec. 21, 2023

(54) SIGNALLING OF SPATIAL RELATION BETWEEN COMPONENT CARRIERS

(71) Applicant: Telefonaktiebolaget LM Ercison (publ), Stockholm (SE)

(72) Inventors: Andreas NILSSON, GÖTEBORG (SE); Pär ANKEL, NÖDINGE (SE); Fredrik ATHLEY, VÄSTRA FRÖLUNDA (SE); Sven PETERSSON, SÄVEDALEN (SE)

(73) Assignee: Telefonaktiebolaget LM Ercison (publ), Stockholm (SE)

(21) Appl. No.: 18/037,660

(22) PCT Filed: Nov. 27, 2020
(86) PCT No.: PCT/EP2020/083775

§ 371 Date: May 18, 2023

(51) Int. Cl. H04W 56/00; H04B 7/06; H04W 16/28

(52) U.S. Cl. CPC H04W 56/0015; H04B 7/06968; H04W 16/28

(57) ABSTRACT

There is provided mechanisms for signalling, towards user equipment, a spatial relation between component carriers on which SSBs are to be transmitted. A method is performed by a network node. The method comprises signalling, towards the user equipment is served by the network node, an indication of spatial QCL among the SSBs to be transmitted on different ones of the component carriers. The method comprises initiating transmission of the SSBs on the component carriers.

### TECHNICAL FIELD

Embodiments presented herein relate to a method, a network node, a computer program, and a computer program product for signalling, towards user equipment, a spatial relation between component carriers on which synchronization signal blocks (SSBs) are to be transmitted. Embodiments presented herein further relate to a method, a user equipment, a computer program, and a computer program product for receiving an indication of a spatial relation between component carriers on which SSBs are to be transmitted.

### BACKGROUND

In communications networks, there may be a challenge to obtain good performance and capacity for a given communications protocol, its parameters and the physical environment in which the communications network is deployed.

For example, for future generations of mobile communications networks, frequency bands at many different component carrier frequencies could be needed. For example, low such frequency bands could be needed to achieve sufficient network coverage for wireless devices and higher frequency bands (e.g. at millimetre wavelengths (mmW), i.e. near and above 30 GHz) could be needed to reach required network capacity. In general terms, at high frequencies the propagation properties of the radio channel are more challenging and beamforming both at the network node of the network and at the wireless devices might be required to reach a sufficient link budget.

Narrow beam transmission and reception schemes might be needed at such high frequencies to compensate the expected high propagation loss. For a given communication link, a respective beam can be applied at both the network-end (as represented by a network node or its transmission and reception point, TRP) and at the user-end (as represented by a user equipment), which typically is referred to as a beam pair link (BPL). A BPL (i.e. both the beam used by the network node and the beam used by the user equipment) is expected to be discovered and monitored by the network using measurements on downlink reference signals, such as channel state information reference signals (CSI-RS) or SSBs, used for beam management.

A beam management procedure can be used for discovery and maintenance of beam pair links. In some aspects, the beam management procedure is defined in terms of a P-1 sub-procedure, a P-2 sub-procedure, and a P-3 sub-procedure.

The CSI-RS for beam management can be transmitted periodically, semi-persistently or aperiodically (event triggered) and they can be either shared between multiple user equipment or be user-specific. The SSB are transmitted periodically and are shared for all user equipment. In order for the user equipment to find a suitable network node beam, the network node, during the P-1 sub-procedure, transmits the reference signal in different transmission (TX) beams on which the user equipment performs measurements, such as reference signal received power (RSRP), and reports back the N best TX beams (where N can be configured by the network). Furthermore, the transmission of the reference signal on a given TX beam can be repeated to allow the user equipment to evaluate a suitable reception (RX) beam. Reference signals that are shared between all user equipment served by the TRP might be used to determine a first coarse direction for the user equipment. It could be suitable for such a periodic TX beam sweep at the TRP to use SSB as the reference signal. One reason for this is that SSB are anyway transmitted periodically (for initial access/synchronization purposes) and SSBs are also expected to be beamformed at higher frequencies to overcome the higher propagation losses noted above.

A finer beam sweep in more narrow beams than used during the P-1 sub-procedure might then be performed at the network node during a P-2 sub-procedure to determine a more detailed direction for each user equipment. Here, the CSI-RS might be used as reference signal. As for the P-1 sub-procedure, the user equipment performs quality measurements, such as reference signal received power (RSRP), and reports back the N best TX beams (where N can be configured by the network).

Furthermore, the CSI-RS transmission in the transmission beam selected during the P-2 sub-procedure can be repeated in a P-3 sub-procedure to allow the user equipment to evaluate suitable RX beams at the user equipment.

However, there is still a risk for polarization mismatching and/or that the available system bandwidth is not efficiently used during the transmission of the SSBs. In turn, this could result in that that the optimum TX beam and/or RX beam (i.e., the TX beam and/or RX beam yielding highest throughput, signal to interference plus noise ratio (SINR), etc.) is not selected during the beam management process.

Hence, there is still a need for an improved, in terms of yielding selection of optimum TX beam and/or RX beam, beam management process.

### SUMMARY

An object of embodiments herein is to enable reliable quality measurements to be obtained by the network node for use, e.g., during a beam management procedure.

According to a first aspect there is presented a method for signalling, towards user equipment, a spatial relation between component carriers on which SSBs are to be transmitted. The method is performed by a network node. The method comprises signalling, towards the user equipment is served by the network node, an indication of spatial QCL among the SSBs to be transmitted on different ones of the component carriers. The method comprises initiating transmission of the SSBs on the component carriers.

According to a second aspect there is presented a network node for signalling, towards user equipment, a spatial relation between component carriers on which SSBs are to be transmitted. The network node comprises processing circuitry. The processing circuitry is configured to cause the network node to signal, towards the user equipment is served by the network node, an indication of spatial QCL among the SSBs to be transmitted on different ones of the component carriers. The processing circuitry is configured to cause the network node to initiate transmission of the SSBs on the component carriers.

According to a third aspect there is presented a network node for signalling, towards user equipment, a spatial relation between component carriers on which SSBs are to be transmitted. The network node comprises a signal module configured to signal, towards the user equipment is served by the network node, an indication of spatial QCL among the SSBs to be transmitted on different ones of the component carriers. The network node comprises an initiate module configured to initiate transmission of the SSBs on the component carriers.

According to a fourth aspect there is presented a computer program for signalling, towards user equipment, a spatial relation between component carriers on which SSBs are to be transmitted. The computer program comprises computer program code which, when run on processing circuitry of a network node, causes the network node to perform a method according to the first aspect.

According to a fifth aspect there is presented a method for receiving an indication of a spatial relation between component carriers on which SSBs are to be transmitted. The method is performed by a user equipment. The method comprises receiving signalling, from a network node serving the user equipment, of an indication of spatial QCL among the SSBs to be transmitted on different ones of the component carriers. The method comprises receiving the SSBs on the component carriers.

According to a sixth aspect there is presented a user equipment for receiving an indication of a spatial relation between component carriers on which SSBs are to be transmitted. The user equipment comprises processing circuitry. The processing circuitry is configured to cause the user equipment to receive signalling, from a network node serving the user equipment, of an indication of spatial QCL among the SSBs to be transmitted on different ones of the component carriers. The processing circuitry is configured to cause the user equipment to receive the SSBs on the component carriers.

According to a seventh aspect there is presented a user equipment for receiving an indication of a spatial relation between component carriers on which SSBs are to be transmitted. The user equipment comprises a receive module configured to receive signalling, from a network node serving the user equipment, of an indication of spatial QCL among the SSBs to be transmitted on different ones of the component carriers. The user equipment comprises a receive module configured to receive the SSBs on the component carriers.

According to an eighth aspect there is presented a computer program for receiving an indication of a spatial relation between component carriers on which SSBs are to be transmitted. The computer program comprises computer program code which, when run on processing circuitry of a user equipment, causes the user equipment to perform a method according to the fifth aspect.

According to a ninth aspect there is presented a computer program product comprising a computer program according to at least one of the fourth aspect and the eighth aspect and a computer readable storage medium on which the computer program is stored. The computer readable storage medium could be a non-transitory computer readable storage medium.

According to a tenth aspect there is presented a communication system comprising at least one network node according to the first or second aspect and at least one user equipment according to the sixth or seventh aspect.

Advantageously, these aspects enable reliable quality measurements to be made by the user equipment and be obtained by the network node for use, e.g., during a beam management procedure.

Advantageously, these aspects enable the frequency diversity to increase for beam management procedures based on transmission of SSBs. In turn this reduces the risk of not selecting the optimal TX beam and/or RX beam during a beam management procedure.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, action, etc.” are to be interpreted openly as referring to at least one instance of the element, apparatus, component, means, module, action, etc., unless explicitly stated otherwise. The actions of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communication network according to embodiments;

FIGS. 2 and 3 are flowcharts of methods according to embodiments;

FIG. 4 is a signalling diagram according to an embodiment;

FIGS. 5 and 6 are schematic illustrations of time/frequency grids where SSB bursts are transmitted on component carriers according to embodiments;

FIG. 7 is a schematic diagram showing functional units of a network node according to an embodiment;

FIG. 8 is a schematic diagram showing functional modules of a network node according to an embodiment;

FIG. 9 is a schematic diagram showing functional units of a user equipment according to an embodiment;

FIG. 10 is a schematic diagram showing functional modules of a user equipment according to an embodiment; and

FIG. 11 shows one example of a computer program product comprising computer readable means according to an embodiment;

FIG. 12 is a schematic diagram illustrating a telecommunication network connected via an intermediate network to a host computer in accordance with some embodiments; and

FIG. 13 is a schematic diagram illustrating host computer communicating via a radio base station with a terminal device over a partially wireless connection in accordance with some embodiments.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any action or feature illustrated by dashed lines should be regarded as optional.

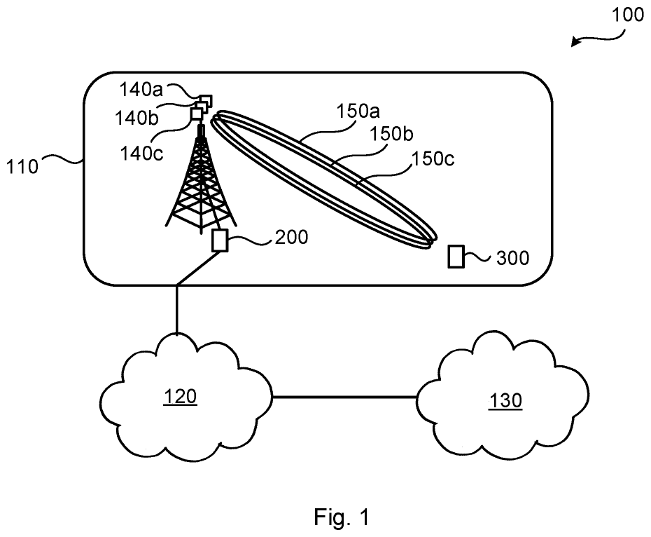

FIG. 1 is a schematic diagram illustrating a communication network 100 where embodiments presented herein can be applied. The communication network 100 could be a third generation (3G) telecommunications network, a fourth generation (4G) telecommunications network, a fifth generation (5G) telecommunications network, or any evolvement thereof, and support any 3GPP telecommunications standard, where applicable.

The communication network 100 comprises a network node 200 configured to provide network access to user equipment, as represented by user equipment 300, in a radio access network 110. The radio access network 110 is operatively connected to a core network 120. The core network 120 is in turn operatively connected to a service network 130, such as the Internet. The user equipment 300 is thereby enabled to, via the network node 200, access services of, and exchange data with, the service network 130.

The network node 200 comprises, is collocated with, is integrated with, or is in operational communications with, at least one transmission and reception point (TRP) 140a, 140b, 140c. The network node 200 (via its at least one TRP 140a, 140b, 140c) and the user equipment 300 are configured to communicate with each other in beams, one of which for each of the TRPs 140a, 140b, 140c is illustrated at reference numerals 150a, 150b, 150c. In this respect, beams that could be used both as TX beams and RX beams will hereinafter simply be referred to as beams.

Examples of network nodes 200 are radio access network nodes, radio base stations, base transceiver stations, Node Bs, evolved Node Bs, gNBs, access points, access nodes, and backhaul nodes. Examples of user equipment 300 are terminal devices, wireless devices, mobile stations, mobile phones, handsets, wireless local loop phones, smartphones, laptop computers, tablet computers, network equipped sensors, network equipped vehicles, and so-called Internet of Things devices.

As disclosed above, there is still a need for an improved, in terms of yielding selection of optimum TX beam and/or RX beam, beam management process.

In this respect, as outlined above, beam management is generally at least partly based on that the user equipment 300 performs some kind of quality measurements (such as RSRP or SINR) on SSBs as transmitted by the network node 200. The user equipment 300 reports the quality measurements to the network node 200 and the user equipment 300 uses the quality measurements to determine the beam selections. Since one SSB only covers 20 physical resource blocks (PRBs), the total bandwidth for the SSB transmission becomes rather small and the quality measurements used by the network node 200 for beam selections can hence become sensitive to frequency selective behaviour of the physical radio propagation channel, which in turn could lead to less than optimal beam selections. In addition, the SSB is only transmitted on a single port (i.e. with a single polarization in each unique direction), which means that polarization mismatch between the network node 200 and the user equipment 300 might occur. This could also lead to less than optimal beam selections.

The embodiments disclosed herein therefore relate to mechanisms for a network node 200 to signalling, towards user equipment 300, a spatial relation between component carriers on which SSBs are to be transmitted and mechanisms for a user equipment 300 for receiving an indication of a spatial relation between component carriers on which SSBs are to be transmitted. In order to obtain such mechanisms there is provided a network node 200, a method performed by the network node 200, a computer program product comprising code, for example in the form of a computer program, that when run on processing circuitry of the network node 200, causes the network node 200 to perform the method. In order to obtain such mechanisms there is further provided a user equipment 300, a method performed by the user equipment 300, and a computer program product comprising code, for example in the form of a computer program, that when run on processing circuitry of the user equipment 300, causes the user equipment 300 to perform the method.

Component carrier aggregation can be used to extend the bandwidth. This is especially applicable for communication networks 100 utilizing mmWave frequencies where the bandwidths are much larger and where it might not be feasible to communicate over the full system bandwidth on the same component carrier.

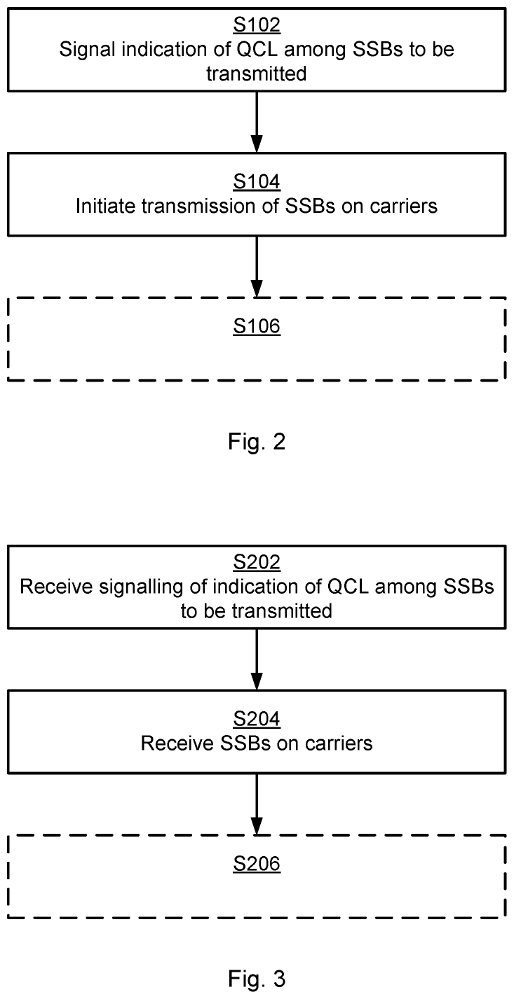

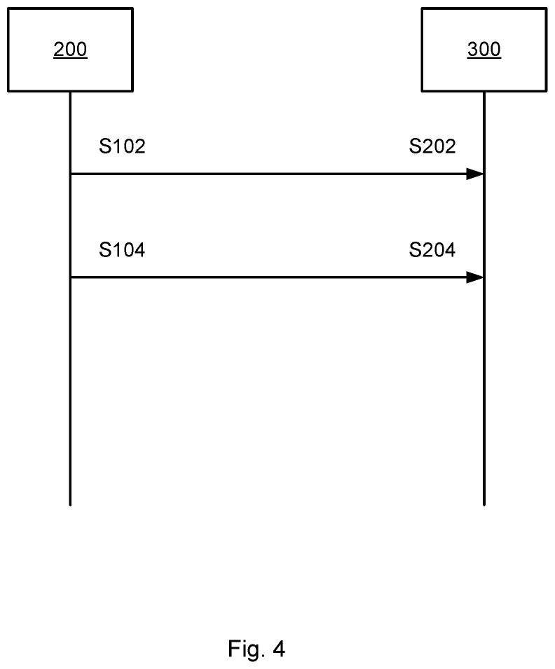

Reference is now made to FIG. 2 illustrating a method for signalling, towards user equipment 300, a spatial relation between component carriers on which SSBs are to be transmitted as performed by the network node 200 according to an embodiment. Parallel reference is made to the signalling diagram of FIG. 4 illustrating the same method.

The method is based on that the network node 200 signals an indication that SSBs belonging to different carries are spatially quasi-collocated. That is, the network node 200 is configured to perform action S102:

S102: The network node 200 signals, towards the user equipment 300 being served by the network node 200, an indication of spatial QCL among the SSBs to be transmitted on different ones of the component carriers.

In some examples, the network node 200 signals the indication by conveying information of the indication. In some examples, the indication is a sign or piece of information that indicates the spatial QCL among the SSBs to be transmitted on different ones of the component carriers.

The SSBs are then transmitted on the component carriers. In particular, the network node 200 is configured to perform action S104:

S104: The network node 200 initiates transmission of the SSBs on the component carriers.

In some examples, the network node 200 initiates transmission of the SSBs by causing transmission to begin of the SSBs, where the SSBs are to be transmitted by being broadcasted or sent. In this respect, the actual transmission of the SSBs over the air interface, and thus on the component carriers, might be performed by the at least one TRP 140a, 140b, 140c.

Advantageously, this method enables reliable quality measurements to be made by the user equipment 300 and obtained by the network node 200 for use, e.g., during a beam management procedure.

Advantageously, this method enables the frequency diversity to increase for beam management procedures based on transmission of SSBs. In turn this reduces the risk of the network node 200 (and/or the user equipment 300) not selecting the optimal TX beam and/or RX beam during a beam management procedure.

In some aspects, the method comprises one or more further, optional, actions, as represented by action S106 in FIG. 2.

Embodiments relating to further details of signalling, towards user equipment 300, a spatial relation between component carriers on which SSBs are to be transmitted as performed by the network node 200 will now be disclosed.

In some examples, a component carrier is a frequency block that might be used for carrier aggregation, where carrier aggregation thus implies that a number of carrier components are aggregated. A serving cell can be configured for a user equipment. This is disclosed with reference to ServingCellConfig in document 3GPP TS 38.331 entitled “NR; Radio Resource Control (RRC); Protocol specification”, version 16.2.0. In the ServingCellConfig one or several bandwidth parts (BWPs) can be configured. In the BWP information element (IE) a frequency block is configured. If multiple serving cells are configured for a user equipment, each with a BWP pointing to different frequency blocks then the user equipment is configured for carrier aggregation with multiple component carriers.

In some examples, the spatial relation corresponds to antenna ports quasi-colocation as described in chapter 5.1.5 of document 3GPP TS 38.214 entitled “NR; Physical layer procedures for data”, version 16.3.0. In some examples, the spatial relation corresponds to that of the UE sounding procedure as described in chapter 6.2.1 of aforementioned document 3GPP TS 38.214 where a spatial relation is described for an SRS resource transmission.

In some aspects, the indication of spatial QCL applies to all component carriers of serving cells belonging to one cell group (either a master cell group (MCG) or a secondary cell group (SCG) as specified in aforementioned document 3GPP TS 38.331). In some aspects, the indication of spatial QCL applies to all component carriers of serving cells (including primary cells (PCells), primary secondary cells (PSCells), secondary cells (PCells), etc.) configured in “CellGroupConfig information element” as specified in aforementioned document 3GPP TS 38.331.

In some examples, The SSBs are defined as in aforementioned document 3GPP TS 38.331.

There may be different indications of spatial QCL that are signalled in action S102. Different embodiments relating thereto will now be described in turn.

In some aspects, the SSBs are to be transmitted using spatial filters. In particular, in some embodiments, each SSB is to be transmitted using a respective spatial filter, and the indication defines which of the SSBs that on the component carriers are to be transmitted using the same spatial filter. The spatial filter per each of the component carriers might define which directional beam 150a, 150b, 150c is used for transmitting the SSBs per each of the component carriers. In some further aspects, the SSBs with same spatial filter are to be simultaneously transmitted. That is, in some embodiments, the SSBs are to be transmitted in timeslots, and the SSBs that on the component carriers are to be transmitted using the same spatial filter are to be transmitted in the same timeslot. That is, in some examples, the same time-wise synchronized orthogonal frequency-division multiplexing (OFDM) symbols are used for the SSBs on the different component carriers.

There may be different ways for the network node 200 to signal the indication of spatial QCL as in action S102. Different embodiments relating thereto will now be described in turn

In some aspects, a flag is used to signal the indication. That is, in some embodiments, the indication is provided as a flag. In some examples there is one flag for all serving cells in an MCG or SCG. In other examples there is one flag per each serving cell within an MCG or SCG. The latter example allows indication that only certain serving cells within an MCG or SCG has same spatial QCL for the SSBs.

There could be different types of flags.

In some aspects, the flag indicates that those SSBs that are to be transmitted on different component carriers but in same time slot are to be transmitted with the same spatial filter. That is, in some embodiments, when the flag is set, the SSBs that on the component carriers are to be transmitted in the same timeslot are to be transmitted using the same spatial filter.

In some aspects, the flag indicates that the SSBs with same SSB index as transmitted on different component carriers are transmitted with the same spatial filter. That is, in some embodiments, each SSB on each component carrier has an index, and, when the flag is set, the SSBs with same index are to, on the component carriers, be transmitted using the same spatial filter.

In some aspects, the network node 200 signals the indication as an explicit mapping. The mapping indicates the spatial relation between the SSBs for different serving cells. That is, in some embodiments, each component carrier is transmitted in a respective serving cell, and the indication is provided as an explicit mapping between the SSBs and the serving cells.

There could be different types of mappings.

In some aspects, the mapping is a table. One such table could be provided per MCG oct SCG or per serving cell with an MCG or SCG. That is, in some embodiments, each SSB per component carrier has an index and the mapping is signalled as a table having columns and rows. According to a first example, each column in the table lists the SSBs indices for a respective component carrier, and all the SSB indices appearing on the same row are to be transmitted using the same spatial filter. According to a second example, each row in the table lists the SSBs indices for a respective component carrier, and all the SSB indices appearing in the same column are to be transmitted using the same spatial filter.

In some embodiments, the indication is signaled in a radio resource control (RRC) message, or in a medium access control (MAC) control element (CE). That is, the flag or the explicit mapping might in action S102 be signaled in an RRC message or in a MAC CE.

In general terms, for any transmission, polarization mismatching might cause a drop in received power at the receiving end. For example, assume that there is a polarization mismatch between the at least one TRP 140a, 140b, 140c and the user equipment 300 such that the received power of the SSBs becomes very poor, then the quality measurements might be very unreliable. Another example is that the user equipment 300 might experience line of sight (LOS) towards the at least one TRP 140a, 140b, 140c, but due to polarization mismatch the quality measurements for the beam being in LOS with the user equipment 300 might yield poor quality, and a beam not being in LOS with the user equipment 300 (e.g., a beam that is reflected on another object) that reach the user equipment 300 with changed polarization, might yield better quality. This might cause the user equipment 300 to select the beam not being in LOS, even though the beam in LOS would have yield much higher quality if the at least one TRP 140a, 140b, 140c and the user equipment 300 were not mismatched with respect to polarization. In some aspects, the SSBs to be transmitted on different component carriers are therefore to be transmitted with different polarizations. That is, in some embodiments, the SSBs on different component carriers are to be transmitted with mutually different polarizations. Advantageously, this reduces the risk of polarization mismatching. Advantageously, this enables reliable quality measurements to be obtained by the network node 200 from the user equipment 300 for use, e.g., during a beam management procedure. In turn this reduces the risk of the network node 200 (and/or the user equipment 300) not selecting the optimal TX beam and/or RX beam during a beam management procedure. In some embodiments, the mutually different polarizations are orthogonal to each other. In some aspects, that the SSBs to be transmitted on different component carriers are to be transmitted with different polarizations is not dependent on that the network node 200 has signalled a spatial relation between component carriers on which SSBs are to be transmitted. Hence, a method performed by the network node 200 for polarized transmission of SSBs might comprise (at least) a action of initiating transmission of the SSBs on different component carriers with mutually different polarizations.

In some aspects, when dual-polarization beamforming is used to generate the SSB beams, the polarization state will change over the angular interval of the SSB beam. That is, in some embodiments, the SSBs are to be transmitted in beams 150a, 150b, 150c using dual-polarization beamforming, where each of the beams 150a, 150b, 150c spans a respective angular interval, and where the polarization changes over the angular interval.

In some aspects, when dual-polarization beamforming is used, each component carrier is transmitted on a separate antenna panel (at the at least one TRP 140a, 140b, 140c). That is, in some embodiments, the SSBs are to be transmitted in beams 150a, 150b, 150c using dual-polarization beamforming, and the SSBs on different component carriers are to be transmitted from different antenna panels.

In some aspects, the communication network 100 is composed of primary cells (PCells) and secondary cells (SCells). One of the component carriers might then be transmitted in a primary cell whereas all remaining component carriers might then be transmitted in respective secondary cells.

As disclosed above, the network node 200 might comprise, be collocated with, be integrated with, or be in operational communications with, at least one TRP 140a, 140b, 140c. In some aspects, each component carrier is generated by a respective TRP 140a, 140b, 140c. In particular, in some embodiments, each of the component carriers is to be transmitted from a respective TRP 140a, 140b, 140c. as further disclosed above, the network node 200 (via its at least one TRP 140a, 140b, 140c) and the user equipment 300 might be configured to communicate with each other in beams. In particular, in some embodiments, all the TRPs 140a, 140b, 140c are co-located, each of the TRPs 140a, 140b, 140c is to transmit its component carrier in a beam 150a, 150b, 150c, and the beams 150a, 150b, 150c of all the TRPs 140a, 140b, 140c have same pointing direction.

In further aspects, the network node 200 might further signal to the user equipment 300 that the user equipment 300 is instructed to measure and report a quality measurement (such as RSRP or SINR) for SSBs belonging to different component carriers, or serving cells.

Reference is now made to FIG. 3 illustrating a method for receiving an indication of a spatial relation between component carriers on which SSBs are to be transmitted as performed by the user equipment 300 according to an embodiment. Parallel reference is made to the signalling diagram of FIG. 4 illustrating the same method.

As disclosed above, the network node 200 in action S102 signals indication of spatial QCL among the SSBs to be transmitted on different ones of the component carriers. It is here assumed that the user equipment 300 receives this signalling. Hence, the user equipment 300 is configured to perform action S202:

S202: The user equipment 300 receives signalling, from a network node 200 serving the user equipment 300, of an indication of spatial QCL among the SSBs to be transmitted on different ones of the component carriers.

As disclosed above, the network node 200 in action S104 initiates transmission of the SSBs. It is here assumed that the user equipment 300 receives the SSBs. Hence, the user equipment 300 is configured to perform action S204:

S204: The user equipment 300 receives the SSBs on the component carriers.

Advantageously, this method enables reliable quality measurements to be made by the user equipment 300 and be provided by the user equipment 300 to the network node 200 for use, e.g., during a beam management procedure.

Advantageously, this method enables the reliability for quality measurements made by the user equipment 300 on SSBs received from the network node 200 (via the TRP 140a, 140b, 140c) to increase when the user equipment 300 is to select its own beam.

Advantageously, this method enables the frequency diversity to increase for beam management procedures based on transmission of SSBs. In turn this reduces the risk of the network node 200 (and/or the user equipment 300) not selecting the optimal TX beam and/or RX beam during a beam management procedure.

In some aspects, the method comprises one or more further, optional, actions, as represented by action S206 in FIG. 3.

Embodiments relating to further details of receiving an indication of a spatial relation between component carriers on which SSBs are to be transmitted as performed by the user equipment 300 will now be disclosed.

The embodiments, aspects, and examples as disclosed above with reference to the network node 200 are applicable also to the user equipment 300.

As disclosed above, in some aspects, the SSBs are to be transmitted using spatial filters. In particular, in some embodiments, each SSB is to be transmitted using a respective spatial filter, and the indication defines which of the SSBs that on the component carriers are to be transmitted using the same spatial filter. The spatial filter per each of the component carriers might define which directional beam 150a, 150b, 150c is used for transmitting the SSBs per each of the component carriers. In some further aspects, the SSBs with same spatial filter are to be simultaneously transmitted. That is, in some embodiments, the SSBs are to be transmitted in timeslots, and the SSBs that on the component carriers are to be transmitted using the same spatial filter are to be transmitted in the same timeslot.

As disclosed above, in some aspects, a flag is used to signal the indication. That is, in some embodiments, the indication is provided as a flag. Different examples of flags as provided above are applicable also here.

As disclosed above, in some aspects, the network node 200 signals the indication as an explicit mapping. The mapping indicates the spatial relation between the SSBs for different serving cells. That is, in some embodiments, each component carrier is transmitted in a respective serving cell, and the indication is provided as an explicit mapping between the SSBs and the serving cells. Different examples of explicit mappings as provided above are applicable also here.

As disclosed above, in some embodiments, the indication is signaled in an RRC message, or in a MAC CE. That is, the flag or the explicit mapping might in action S202 be received in an RRC message or in a MAC CE.

As disclosed above, in some aspects, the SSBs to be transmitted on different component carriers are to be transmitted with different polarizations. That is, in some embodiments, the SSBs on different component carriers are to be transmitted with mutually different polarizations. Advantageously, this enables reliable quality measurements to be obtained by the network node 200 from the user equipment 300 for use, e.g., during a beam management procedure. In turn this reduces the risk of the network node 200 not selecting the optimal TX beam and/or RX beam during a beam management procedure. In some embodiments, the mutually different polarizations are orthogonal to each other.

Further aspects, as applicable to both the network node 200 and the user equipment 300, of the above embodiments relating to signalling, towards user equipment 300, a spatial relation between component carriers on which SSBs are to be transmitted will now be disclosed.

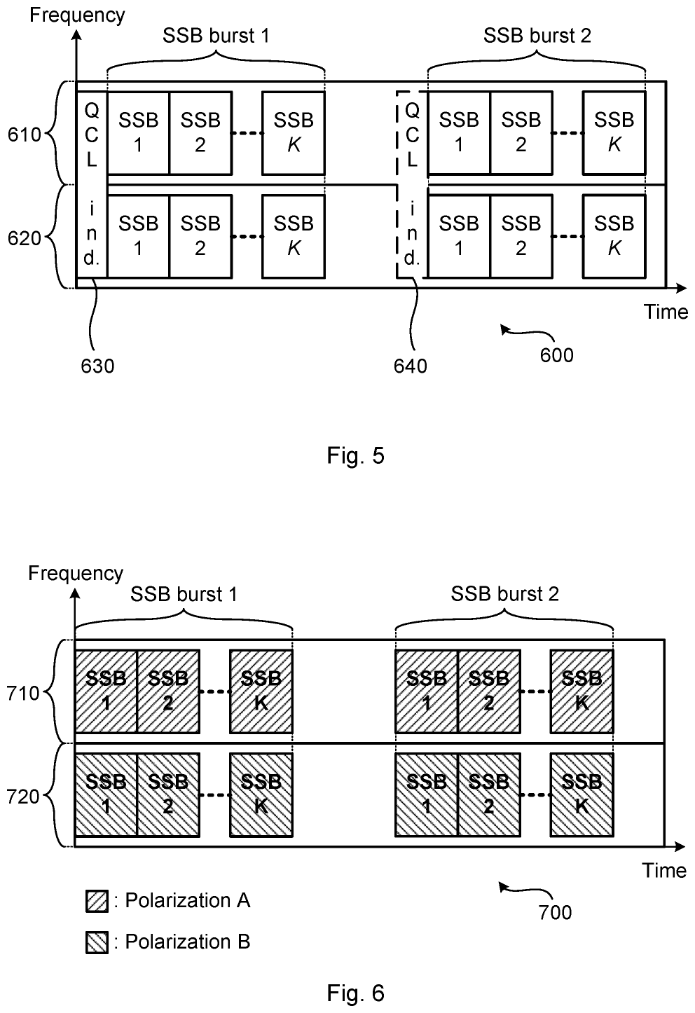

In some aspects, the network node 200 signals a flag (e.g. using RRC signaling), or one flag per serving cell of an MCG or an SCG, to the user equipment 300 that indicates to the user equipment 300 that the user equipment 300 can assume that SSBs transmitted on different component carriers but in the same time slot (i.e. in the same OFDM symbols) are transmitted with the same spatial filter. An example of this is illustrated in FIG. 5. FIG. 5 schematically illustrates a time/frequency grid 600 where a first SSB burst (SSB burst 1) and a second SSB burst (SSB burst 2) are transmitted on two component carriers 610, 620. In each SSB burst, K SSBs are transmitted on each component carrier. SSB burst 1 is preceded by signalling of an indication 630 of spatial QCL among the SSBs to be transmitted on different ones of the component carriers 610, 620. SSB burst 2 is preceded by signalling of a further (optional) indication 640 of spatial QCL among the SSBs to be transmitted on different ones of the component carriers 610, 620. This further (optional) indication 640 could be signalled if the spatial QCL among the SSBs to be transmitted has changed since the preceding SSB burst but might otherwise be omitted. Further, the indications 630, 640 might not occupy the whole frequency resources of the component carriers 610, 620; the indications 630, 640 might be transmitted in only a part of each of the component carriers 610, 620 or even in a part of only one of the component carriers 610, 620.

In some aspects, the flag instead indicates that the same SSB index transmitted on different component carriers are transmitted with the same spatial filter. For example, this could mean that the user equipment 300 can assume that all SSBs with same SSB index (e.g. given by the parameter ssb-PositionsInBurst) from all TRPs 140a, 140b, 140c have the same spatial relation.

In some aspects, the network node 200 signals an explicit table (for example using RRC signaling) to the user equipment 300, where the table indicates the spatial QCL relation between SSBs for different serving cells, where each serving cell corresponds to a respective component carrier. Table 1 provides an illustrative example of such a table. According to the illustrative example of Table 1 there are four serving cells (serving cell 1, serving cell 2, serving cell 3, and serving cell 4) and 10 different SSB indices. In this example, SSBs located on the same row of the table can be assumed to be spatially spatial QCL with each other. That is, SSB 1 of serving cell 1, SSB 5 of serving cell 2, SSB 1 of serving cell 3 and SSB 4 of serving cell 4 are all assumed to be spatially spatial QCL with each other.

TABLE 1
Spatial QCL relation between SSBs for different serving cells

| Serving | Serving | Serving | Serving |
|---|---|---|---|
| cell 1 | cell 2 | cell 3 | cell 4 |
| SSB 1 | SSB 5 | SSB 1 | SSB 4 |
| SSB 2 | SSB 6 | SSB 2 | SSB 5 |
| SSB 3 | SSB 7 | SSB 3 | SSB 6 |
| SSB 4 | SSB 8 | SSB 4 | SSB 1 |
| SSB 5 | SSB 9 | SSB 5 | SSB 2 |
| SSB 6 | SSB 10 | SSB 6 | SSB 3 |

Further aspects, as applicable to both the network node 200 and the user equipment 300, of the above embodiments relating to where the SSBs to be transmitted on different component carriers are to be transmitted with different polarizations will now be disclosed.

Assume a communication network where two component carriers are used and where a burst of SSBs are transmitted per component carrier, as illustrated in FIG. 6. FIG. 6 schematically illustrates a time/frequency grid 700 where a first SSB burst (SSB burst 1) and a second SSB burst (SSB burst 2) are transmitted on two component carriers 710, 720. In each SSB burst, K SSBs are transmitted on each component carrier. The SSB bursts on component carrier 710 are transmitted using polarization A, whereas the SSB bursts on component carrier 720 are transmitted using polarization B. For example, polarization A might be vertical polarization and polarization B might be horizontal polarization. This means that a user equipment 300 that reports quality measurements based on SSBs can receive SSB with two mutually orthogonal polarizations (and SSBs at multiple different frequency bands), leading to more reliable quality measurements, and hence beam selections, during a beam management procedure.

In some aspects, dual-polarized beamforming is used to generate the SSB beams. Then, the polarization state might change over the angular interval of the SSB beam. The two sets of SSBs (one set per component carrier) can be transmitted with orthogonal polarizations in each direction by properly selected antenna beam weights being applied when the SSBs are transmitted. In some aspects, each component carrier is transmitted using its own set of time-domain phase shifters. In some aspects, each component carrier is transmitted from a separate antenna panel.

It is noted that vertical and horizontal polarization are just two examples. In this respect, although the example shown in FIG. 6 only shows the use of two component carriers, the herein disclosed embodiments can be applied to any number of component carriers (but at minimum two component carriers) where the SSB for each component carrier has different polarizations in order to maximize the polarization diversity. If, for example, four component carriers are used with single polarized beamforming, the following polarization states could be used: vertical polarization for first component carrier, horizontal polarization for second component carrier, right-hand circular polarization for third component carrier, and left-hand circular polarization for fourth component carrier. With more than two component carriers and dual-polarized beamforming, the antenna beam weights could be selected such that individual polarizations are not the same for all component carriers, but still that all component carriers are transmitted with the (at least almost) same power pattern.

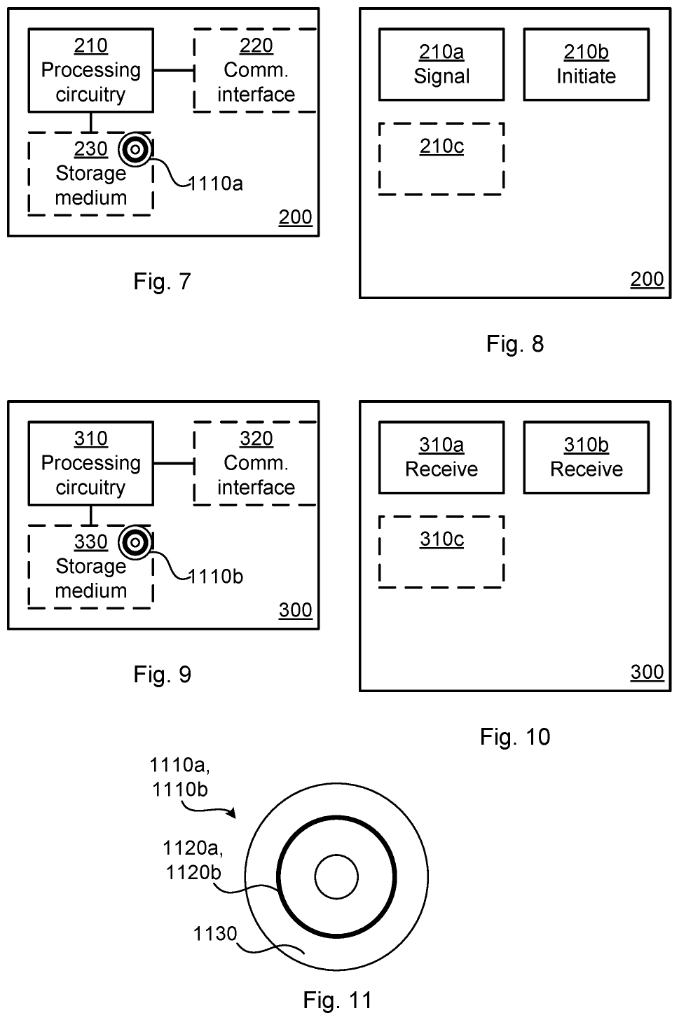

FIG. 7 schematically illustrates, in terms of a number of functional units, the components of a network node 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 1110a (as in FIG. 11), e.g. in the form of a storage medium 230. The processing circuitry 210 may further be provided as at least one application specific integrated circuit (ASIC), or field programmable gate array (FPGA).

Particularly, the processing circuitry 210 is configured to cause the network node 200 to perform a set of operations, or actions, as disclosed above. For example, the storage medium 230 may store the set of operations, and the processing circuitry 210 may be configured to retrieve the set of operations from the storage medium 230 to cause the network node 200 to perform the set of operations. The set of operations may be provided as a set of executable instructions. Thus the processing circuitry 210 is thereby arranged to execute methods as herein disclosed.

The storage medium 230 may also comprise persistent storage, which, for example, can be any single one or combination of magnetic memory, optical memory, solid state memory or even remotely mounted memory.

The network node 200 may further comprise a communications interface 220 for communications with other entities, nodes, functions, and devices of the communication network 100. As such the communications interface 220 may comprise one or more transmitters and receivers, comprising analogue and digital components.

The processing circuitry 210 controls the general operation of the network node 200 e.g. by sending data and control signals to the communications interface 220 and the storage medium 230, by receiving data and reports from the communications interface 220, and by retrieving data and instructions from the storage medium 230. Other components, as well as the related functionality, of the network node 200 are omitted in order not to obscure the concepts presented herein.

FIG. 8 schematically illustrates, in terms of a number of functional modules, the components of a network node 200 according to an embodiment. The network node 200 of FIG. 8 comprises a number of functional modules; a signal module 210a configured to perform action S102, and an initiate module 210b configured to perform action S104. The network node 200 of FIG. 8 may further comprise a number of optional functional modules, as represented by functional module 210c configured to perform optional action S106. In general terms, each functional module 210a:210c may be implemented in hardware or in software. Preferably, one or more or all functional modules 210a:210c may be implemented by the processing circuitry 210, possibly in cooperation with the communications interface 220 and/or the storage medium 230. The processing circuitry 210 may thus be arranged to from the storage medium 230 fetch instructions as provided by a functional module 210a:210c and to execute these instructions, thereby performing any actions of the network node 200 as disclosed herein.

The network node 200 may be provided as a standalone device or as a part of at least one further device. For example, the network node 200 may be provided in a node of the radio access network or in a node of the core network. Alternatively, functionality of the network node 200 may be distributed between at least two devices, or nodes. These at least two nodes, or devices, may either be part of the same network part (such as the radio access network or the core network) or may be spread between at least two such network parts. In general terms, instructions that are required to be performed in real time may be performed in a device, or node, operatively closer to the cell than instructions that are not required to be performed in real time.

Thus, a first portion of the instructions performed by the network node 200 may be executed in a first device, and a second portion of the instructions performed by the network node 200 may be executed in a second device; the herein disclosed embodiments are not limited to any particular number of devices on which the instructions performed by the network node 200 may be executed. Hence, the methods according to the herein disclosed embodiments are suitable to be performed by a network node 200 residing in a cloud computational environment. Therefore, although a single processing circuitry 210 is illustrated in FIG. 7 and the processing circuitry 210 may be distributed among a plurality of devices, or nodes. The same applies to the functional modules 210a:210c of FIG. 8 and the computer program 1120a of FIG. 11.

FIG. 9 schematically illustrates, in terms of a number of functional units, the components of a user equipment 300 according to an embodiment. Processing circuitry 310 is provided using any combination of one or more of a suitable central processing unit (CPU), multiprocessor, microcontroller, digital signal processor (DSP), etc., capable of executing software instructions stored in a computer program product 1110b (as in FIG. 11), e.g. in the form of a storage medium 330. The processing circuitry 310 may further be provided as at least one application specific integrated circuit (ASIC), or field programmable gate array (FPGA).

Particularly, the processing circuitry 310 is configured to cause the user equipment 300 to perform a set of operations, or actions, as disclosed above. For example, the storage medium 330 may store the set of operations, and the processing circuitry 310 may be configured to retrieve the set of operations from the storage medium 330 to cause the user equipment 300 to perform the set of operations. The set of operations may be provided as a set of executable instructions. Thus the processing circuitry 310 is thereby arranged to execute methods as herein disclosed.

The storage medium 330 may also comprise persistent storage, which, for example, can be any single one or combination of magnetic memory, optical memory, solid state memory or even remotely mounted memory.

The user equipment 300 may further comprise a communications interface 320 for communications with other entities, nodes, functions, and devices of the communication network 100. As such the communications interface 320 may comprise one or more transmitters and receivers, comprising analogue and digital components.

The processing circuitry 310 controls the general operation of the user equipment 300 e.g. by sending data and control signals to the communications interface 320 and the storage medium 330, by receiving data and reports from the communications interface 320, and by retrieving data and instructions from the storage medium 330. Other components, as well as the related functionality, of the user equipment 300 are omitted in order not to obscure the concepts presented herein.

FIG. 10 schematically illustrates, in terms of a number of functional modules, the components of a user equipment 300 according to an embodiment. The user equipment 300 of FIG. 10 comprises a number of functional modules; a (first) receive module 310a configured to perform action S202, and a (second) receive module 310b configured to perform action S204. The user equipment 300 of FIG. 10 may further comprise a number of optional functional modules, as represented by functional module 310c configured to perform optional action S206. In general terms, each functional module 310a:310c may be implemented in hardware or in software. Preferably, one or more or all functional modules 310a:310c may be implemented by the processing circuitry 310, possibly in cooperation with the communications interface 320 and/or the storage medium 330. The processing circuitry 310 may thus be arranged to from the storage medium 330 fetch instructions as provided by a functional module 310a:310c and to execute these instructions, thereby performing any actions of the user equipment 300 as disclosed herein.

A communication system as disclosed herein might comprise at least one network node 200 as disclosed herein and at least one user equipment as disclosed herein.

FIG. 11 shows one example of a computer program product 1110a, 1110b comprising computer readable means 1130. On this computer readable means 1130, a computer program 1120a can be stored, which computer program 1120a can cause the processing circuitry 210 and thereto operatively coupled entities and devices, such as the communications interface 220 and the storage medium 230, to execute methods according to embodiments described herein. The computer program 1120a and/or computer program product 1110a may thus provide means for performing any actions of the network node 200 as herein disclosed. On this computer readable means 1130, a computer program 1120b can be stored, which computer program 1120b can cause the processing circuitry 310 and thereto operatively coupled entities and devices, such as the communications interface 320 and the storage medium 330, to execute methods according to embodiments described herein. The computer program 1120b and/or computer program product 1110b may thus provide means for performing any actions of the user equipment 300 as herein disclosed.

In the example of FIG. 11, the computer program product 1110a, 1110b is illustrated as an optical disc, such as a CD (compact disc) or a DVD (digital versatile disc) or a Blu-Ray disc. The computer program product 1110a, 1110b could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1120a, 1120b is here schematically shown as a track on the depicted optical disk, the computer program 1120a, 1120b can be stored in any way which is suitable for the computer program product 1110a, 1110b.

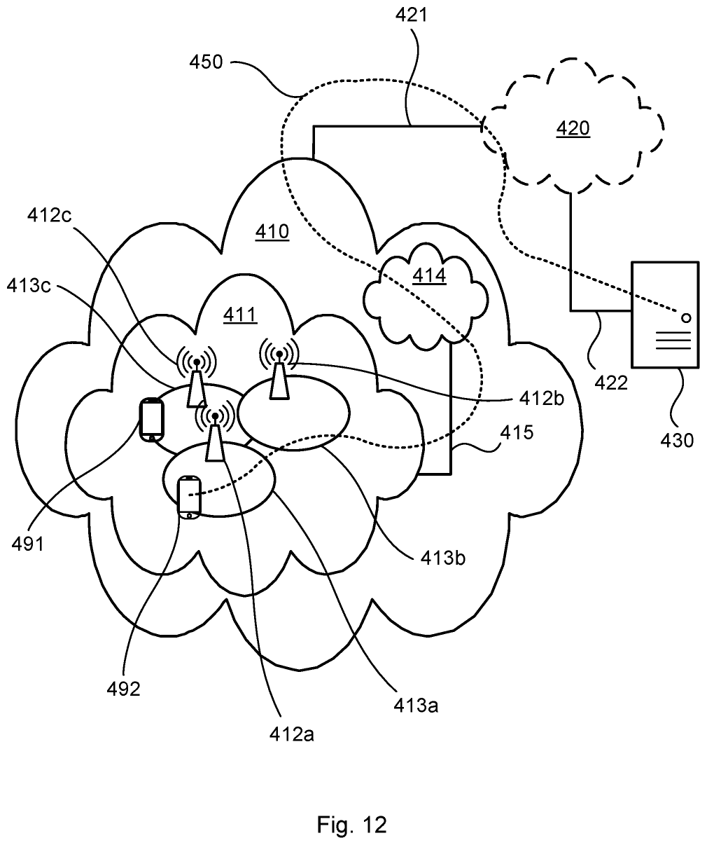

FIG. 12 is a schematic diagram illustrating a telecommunication network connected via an intermediate network 420 to a host computer 430 in accordance with some embodiments. In accordance with an embodiment, a communication system includes telecommunication network 410, such as a 3GPP-type cellular network, which comprises access network 411, such as radio access network 110 in FIG. 1, and core network 414, such as core network 120 in FIG. 1. Access network 411 comprises a plurality of radio access network nodes 412a, 412b, 412c, such as NBs, eNBs, gNBs (each corresponding to the network node 200 of FIG. 1) or other types of wireless access points, each defining a corresponding coverage area, or cell, 413a, 413b, 413c. Each radio access network nodes 412a, 412b, 412c is connectable to core network 414 over a wired or wireless connection 415. A first UE 491 located in coverage area 413c is configured to wirelessly connect to, or be paged by, the corresponding network node 412c. A second UE 492 in coverage area 413a is wirelessly connectable to the corresponding network node 412a. While a plurality of UE 491, 492 are illustrated in this example, the disclosed embodiments are equally applicable to a situation where a sole UE is in the coverage area or where a sole terminal device is connecting to the corresponding network node 412. The UEs 491, 492 correspond to the user equipment 300 of FIG. 1.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider, or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 12 as a whole enables connectivity between the connected UEs 491, 492 and host computer 430. The connectivity may be described as an over-the-top (OTT) connection 450. Host computer 430 and the connected UEs 491, 492 are configured to communicate data and/or signalling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, network node 412 may not or need not be informed about the past routing of an incoming downlink communication with data originating from host computer 430 to be forwarded (e.g., handed over) to a connected UE 491. Similarly, network node 412 need not be aware of the future routing of an outgoing uplink communication originating from the UE 491 towards the host computer 430.

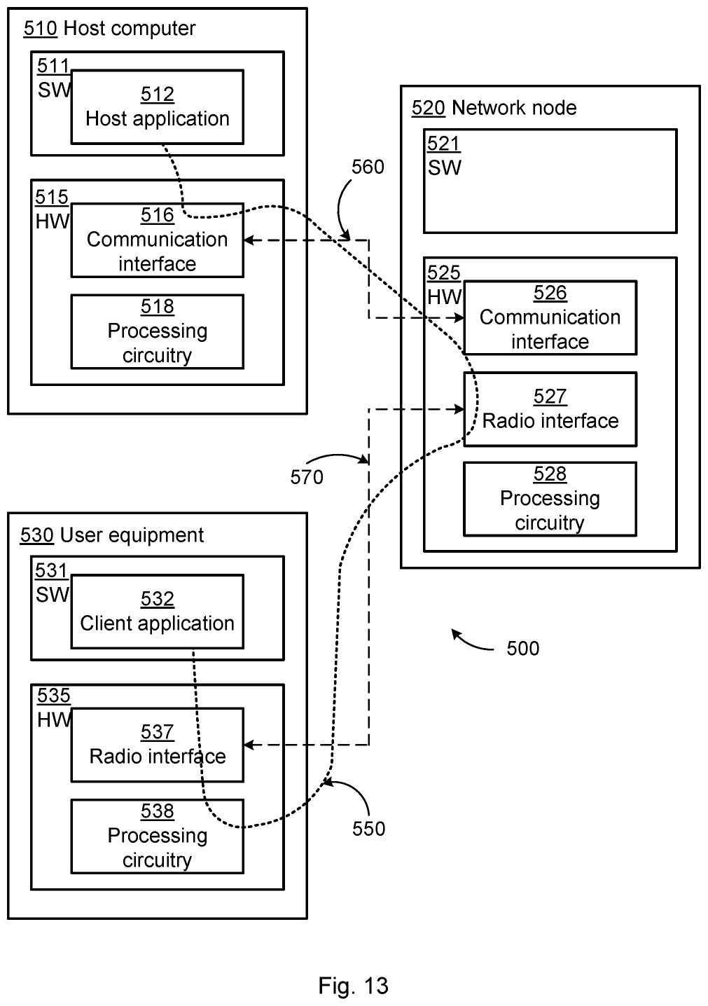

FIG. 13 is a schematic diagram illustrating host computer communicating via a radio access network node with a UE over a partially wireless connection in accordance with some embodiments. Example implementations, in accordance with an embodiment, of the UE, radio access network node and host computer discussed in the preceding paragraphs will now be described with reference to FIG. 13. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. The UE 530 corresponds to the user equipment 300 of FIG. 1. In providing the service to the remote user, host application 512 may provide user data which is transmitted using OTT connection 550.

Communication system 500 further includes radio access network node 520 provided in a telecommunication system and comprising hardware 525 enabling it to communicate with host computer 510 and with UE 530. The radio access network node 520 corresponds to the network node 200 of FIG. 1. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 13) served by radio access network node 520.

Communication interface 526 may be configured to facilitate connection 560 to host computer 510. Connection 560 may be direct or it may pass through a core network (not shown in FIG. 13) of the telecommunication system and/or through one or more intermediate networks outside the telecommunication system. In the embodiment shown, hardware 525 of radio access network node 520 further includes processing circuitry 528, which may comprise one or more programmable processors, application-specific integrated circuits, field programmable gate arrays or combinations of these (not shown) adapted to execute instructions. Radio access network node 520 further has software 521 stored internally or accessible via an external connection.

Communication system 500 further includes UE 530 already referred to. Its hardware 535 may include radio interface 537 configured to set up and maintain wireless connection 570 with a radio access network node serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, radio access network node 520 and UE 530 illustrated in FIG. 13 may be similar or identical to host computer 430, one of network nodes 412a, 412b, 412c and one of UEs 491, 492 of FIG. 12, respectively. This is to say, the inner workings of these entities may be as shown in FIG. 13 and independently, the surrounding network topology may be that of FIG. 12.

In FIG. 13, OTT connection 550 has been drawn abstractly to illustrate the communication between host computer 510 and UE 530 via network node 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., on the basis of load balancing consideration or reconfiguration of the network).

Wireless connection 570 between UE 530 and radio access network node 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may reduce interference, due to improved classification ability of airborne UEs which can generate significant interference.

A measurement procedure may be provided for the purpose of monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above, or supplying values of other physical quantities from which software 511, 531 may compute or estimate the monitored quantities. The reconfiguring of OTT connection 550 may include message format, retransmission settings, preferred routing etc.; the reconfiguring need not affect network node 520, and it may be unknown or imperceptible to radio access network node 520. Such procedures and functionalities may be known and practiced in the art. In certain embodiments, measurements may involve proprietary UE signalling facilitating host computer's 510 measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for signalling, towards a user equipment, a spatial relation between component carriers on which synchronization signal blocks (SSBs) are to be transmitted, the method being performed by a network node, the method comprising:
signalling, towards the user equipment being served by the network node, an indication of spatial quasi-colocation (QCL) among the SSBs to be transmitted on different ones of the component carriers; and
initiating transmission of the SSBs on the component carriers, wherein
each SSB is to be transmitted using a respective spatial filter,
the indication defines which of the SSBs that on the component carriers are to be transmitted using the same spatial filter, and
the SSBs are to be transmitted in timeslots, and wherein the SSBs that on the component carriers are to be transmitted using the same spatial filter are to be transmitted in the same timeslot.

2-4. (canceled)

5. The method of claim 1, wherein the indication is provided as a flag.

6. The method of claim 5, wherein, when the flag is set, the SSBs that on the component carriers are to be transmitted in the same timeslot are to be transmitted using the same spatial filter.

7. The method of claim 5, wherein each SSB on each component carrier has an index, and wherein, when the flag is set, the SSBs with same index are to, on the component carriers, be transmitted using the same spatial filter.

8. The method of claim 1, wherein each component carrier is transmitted in a respective serving cell, and wherein the indication is provided as an explicit mapping between the SSBs and the serving cells.

9. The method of claim 8, wherein each SSB per component carrier has an index, wherein the mapping is signaled as a table having columns and rows, wherein each column in the table lists the SSBs indices for a respective component carrier, and wherein all the SSB indices appearing on the same row are to be transmitted using the same spatial filter.

10. The method of claim 8, wherein each SSB per component carrier has an index, wherein the mapping is signaled as a table having columns and rows, wherein each row in the table lists the SSBs indices for a respective component carrier, and wherein all the SSB indices appearing in the same column are to be transmitted using the same spatial filter.

11. The method of claim 1, wherein the indication is signaled in a radio resource control message, or a medium access control control element.

12-15. (canceled)

16. The method of claim 1, wherein one of the component carriers is to be transmitted in a primary cell and all remaining component carriers are to be transmitted in respective secondary cells.

17. The method of claim 1, wherein each of the component carriers is to be transmitted from a respective transmission and reception point.

18. The method of claim 17, wherein all the TRPs are co-located, wherein each of the TRPs is to transmit its component carrier in a beam, and wherein the beams of all the TRPs have same pointing direction.

19. A method for receiving an indication of a spatial relation between component carriers on which synchronization signal blocks (SSBs) are to be transmitted, the method being performed by a user equipment, the method comprising:
receiving signalling, from a network node serving the user equipment, of an indication of spatial quasi-colocation (QCL) among the SSBs to be transmitted on different ones of the component carriers; and
receiving the SSBs on the component carriers, wherein
each SSB is to be transmitted using a respective spatial filter,
the indication defines which of the SSBs that on the component carriers are to be transmitted using the same spatial filter, and
the SSBs are to be transmitted in timeslots, and wherein the SSBs that on the component carriers are to be transmitted using the same spatial filter are to be transmitted in the same timeslot.

20-22. (canceled)

23. The method of claim 19, wherein the indication is provided as a flag.

24. The method of claim 19, wherein each component carrier is transmitted in a respective serving cell, and wherein the indication is provided as an explicit mapping between the SSBs and the serving cells.

25. The method of claim 19, wherein the indication is signaled in a radio resource control message, or a medium access control control element.

26. (canceled)

27. A network node for signalling, towards a user equipment, a spatial relation between component carriers on which synchronization signal blocks (SSBs) are to be transmitted, the network node comprising processing circuitry, the processing circuitry being configured to cause the network node to:
signal, towards the user equipment being served by the network node, an indication of spatial quasi-colocation (QCL) among the SSBs to be transmitted on different ones of the component carriers; and
initiate transmission of the SSBs on the component carriers.

28-29. (canceled)

30. A user equipment for receiving an indication of a spatial relation between component carriers on which synchronization signal blocks (SSBs) are to be transmitted, the user equipment comprising processing circuitry, the processing circuitry being configured to cause the user equipment to:
receive signalling, from a network node serving the user equipment, of an indication of spatial quasi-colocation (QCL) among the SSBs to be transmitted on different ones of the component carriers; and
receive the SSBs on the component carriers.

31-33. (canceled)

34. A non-transitory computer readable storage medium storing a computer program for signalling, towards a user equipment, a spatial relation between component carriers on which synchronization signal blocks (SSBs) are to be transmitted, the computer program comprising computer code which, when run on processing circuitry of a network node, causes the network node to:
signal, towards the user equipment being served by the network node, an indication of spatial quasi-colocation (QCL) among the SSBs to be transmitted on different ones of the component carriers; and
initiate transmission of the SSBs on the component carriers.

35. A non-transitory computer readable storage medium storing a computer program for receiving an indication of a spatial relation between component carriers on which synchronization signal blocks (SSBs) are to be transmitted, the computer program comprising computer code which, when run on processing circuitry of a user equipment, causes the user equipment to:
receive signalling, from a network node serving the user equipment, of an indication of spatial quasi-colocation (QCL) among the SSBs to be transmitted on different ones of the component carriers; and
receive the SSBs on the component carriers.

36. (canceled)
